(19) United States
(12) Patent Application Publication
(10) Pub. No.: US 2017/0233637 A1
(43) Pub. Date: Aug. 17, 2017

(54) METHODS FOR INHIBITING METAL CORROSION

(71) Applicant: OHIO UNIVERSITY, Athens, OH (US)

(72) Inventors: Srdjan NESIC, Athens, OH (US); Marc SINGER, Athens, OH (US); Fernando FARELAS-VALENCIA, Athens, OH (US); Thanh Nam VU, Athens, OH (US); David YOUNG, Athens, OH (US); Zineb BELARBI, Bejaia (DZ)

(73) Assignee: Ohio University

(21) Appl. No.: 15/501,548

(22) PCT Filed: Jul. 31, 2015
(86) PCT No.: PCT/US2015/043041

§ 371 Date: Feb. 3, 2017

Related U.S. Application Data
(60) Provisional application No. 62/032,837, filed on Aug. 4, 2014.

(51) Int. Cl. C09K 8/54; E21B 41/02; C23F 11/02

(52) U.S. Cl. CPC C09K 8/54; C23F 11/02; E21B 41/02; C09K 2208/32

(57) ABSTRACT

A method of inhibiting corrosion of ferrous metals in oil and gas well drilling and production systems is provided. The method includes adding to the system an effective quantity of a volatile corrosion inhibiting (VCI) composition comprising a volatile thiol compound, such as 1-decanethiol, 1-dodecanthiol and 11-mercaptoundecanoic acid, where the VCI composition inhibits or minimizes corrosion.

### CROSS-REFERENCE TO RELATED APPLICATIONS

This application claims the benefit of U.S. Provisional Application No. 62/037,837, filed Aug. 4, 2014, the disclosure of which is hereby incorporated by reference herein in its entirety.

### FIELD OF THE INVENTION

The present invention relates to methods for inhibiting metal corrosion, and more particularly to inhibiting top of the line corrosion in wet gas transportation.

### BACKGROUND OF THE INVENTION

As the oil and gas emerge from geological formations, they are accompanied by some water and varying amounts of “acid gases,” e.g., carbon dioxide (CO₂), hydrogen sulfide (H₂S), and organic acids, that create a corrosive combination. This corrosive combination can induce corrosion in ferrous materials, such as mild steel, which in turn can affect the integrity of mild steel. Despite the fact that this has been known for over 100 years, aqueous CO₂/H₂S/organic acid corrosion of mild steel still represents a significant problem for the oil and gas industry. Although corrosion resistance alloys that are able to withstand this type of corrosion are available, mild steel is still the most cost effective construction material used in this industry. Virtually all of the pipelines and most of the processing equipment in the oil and gas industry are built out of mild steel. The cost of equipment failure due to internal CO₂/H₂S/organic acid corrosion is enormous, both in terms of direct costs such as: repair costs and lost production, as well as in indirect costs such as: environmental cost, impact on the downstream industries, etc.

When transporting humid natural gas via so called “wet gas” pipelines over long distances, due to the cooling of the stream, condensation of water vapor and light hydrocarbons occurs on the internal pipe wall. Due to dissolved CO₂, H₂S, and organic acids, the condensed water typically has a pH value less than about 4, therefore making it very corrosive. In stratified flow, where water and liquid hydrocarbons flow in a thin layer at the bottom of the line and the gas flows above them, this situation gives rise to the so-called top-of-the-line corrosion (TLC) scenario. If the rate of condensation is high (typical for hot non-insulated pipelines), plenty of acidic water forms and flows down the internal pipe walls leading to a challenging situation where there are no easy ways to protect the line from internal corrosion. A very limited range of corrosion management options for TLC exists, with corrosion inhibitors being one of them.

Corrosion inhibitors are chemicals commonly added in very small quantities to the flow stream in order to retard the corrosion process. Many classes of chemicals, of widely varying structures, have been used for the inhibition of mild steel corrosion. Many classes of corrosion inhibitors useful in oilfield applications are highly toxic and in some cases non-biodegradable. Many corrosion inhibitors interfere with the oil-water separation process, which can result in relatively larger amounts of residual crude oil contaminants being discharged into the ocean after separation. Moreover, there is a growing concern regarding the environmental impact of corrosion inhibitors.

Most corrosion inhibitors are practically non-volatile and when added to the fluid stream they reside in the water phase at the bottom of the line, providing corrosion protection. It has generally been considered very difficult to enable corrosion inhibitors to reach the sides and the top of the internal pipe wall where they would protect the steel from corrosion by condensed water, as encountered in wet gas pipelines.

One example of a common corrosion inhibitor is polyaspartates, which are biodegradable, low toxicity materials with known corrosion inhibiting activity. U.S. Pat. No. 5,607,623 to Benton et al. describes the use of polyaspartates to inhibit ferrous metal corrosion in carbon dioxide containing aqueous systems. Polyaspartates are useful corrosion inhibitors, affording 70 to 85% corrosion inhibition in carbon dioxide containing oilfield brines.

Triazones and triazine thiones are also chemicals with known corrosion inhibiting activity. U.S. Pat. No. 4,631,138 to Johns et al. describes the use of triazones and triazine thiones as corrosion inhibitors for ferrous metals in carbon dioxide containing aqueous systems.

Amide derivatives of long chain amines have been proposed as environmentally acceptable corrosion inhibitors in oil production applications. See for example Darling et al., “Green Chemistry Applied to Corrosion and Scale Inhibitors” CORROSION 98, Paper No. 207, National Association of Corrosion Engineers (1998). Unfortunately, such materials can be difficult to formulate and can adversely affect the oil water separation process.

Thioglycolic acid (mercaptoacetic acid) is known to be an inhibitor of corrosion. Thioglycolic acid has been used as a corrosion inhibitor in oilfield applications, however it is only partially effective at inhibiting corrosion in a carbon dioxide saturated environment. See, for example, U.S. Pat. No. 5,853,619 to Watson et al.

There are many others types of chemicals with similar functionalities, which enable them to act as effective corrosion inhibitors for mild steel. In all cases, they can inhibit corrosion only where the carrier fluid is in direct contact with pipe wall. However, for the case of TLC in wet gas pipelines, where condensing of water and hydrocarbon is seen, these types of chemicals have shown to be ineffective. Being poorly volatile and/or highly liquid soluble, they cannot effectively reach the sides and top of the line where corrosion is most severe.

Accordingly, there is a need for more effective, environmentally-acceptable, low toxicity corrosion inhibitors for ferrous metal, e.g., mild steel, components to protect against TLC in oil and gas well drilling and production systems.

### SUMMARY OF THE INVENTION

In accordance with an embodiment of the present invention, a method of inhibiting corrosion of ferrous metals by a fluid obtained from oil and gas well drilling and production systems is provided. The method includes adding to the system an effective amount of a volatile corrosion inhibiting (VCI) composition comprising a volatile thiol compound.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to describe the invention.

FIG. 1 is a schematic showing an experimental set up for VCI testing for Bottom of the Line Corrosion (BLC) specimens.

FIG. 2 is a schematic showing an experimental set up for VCI testing for Top of the Line Corrosion (TLC) specimens.

FIG. 3 is graph showing BLC rates and open circuit potentials (OCP) of an X65 rotating cylinder electrode (RCE) in carbon dioxide saturated 1 wt % NaCl solution at 25° C. with 400 parts per million by volume (ppmᵥ) 1-decanethiol and without 1-decanethiol.

FIG. 4 is graph showing BLC rates and OCPs of an X65 RCE in carbon dioxide saturated 1 wt % NaCl solution at 25° C. with 400 ppmᵥ 1-hexanethiol and without 1-hexanethiol.

FIG. 5 is graph showing BLC rates and OCPs of an X65 RCE in carbon dioxide saturated 1 wt % NaCl solution at 25° C. as a function of time before and after injection of 400 ppmᵥ of 1-decanethiol.

FIG. 6 is a graph showing a comparison of BLC rates and OCPs from FIGS. 3 and 5.

FIGS. 7A-7E are surface images of TLC specimens in the presence of A) no inhibitor; B) 100 ppmᵥ 1-hexanethiol; C) 400 ppmᵥ 1-hexanethiol; D) 100 ppmᵥ 1-decanethiol; E) 400 ppmᵥ 1-decanethiol, respectively, after 2 days.

FIG. 8 is a bar graph showing a comparison of corrosion rates obtained by weight loss measurement of uninhibited and inhibited TLC specimens.

FIGS. 9A-9B are scanning electron micrograph (SEM) images at two different magnifications (×100 and ×1000) taken of a TLC specimen inhibited using 100 ppmᵥ 1-hexanethiol as shown in FIG. 7B.

FIGS. 10A-10B are Energy Dispersive X-ray Spectrographic (EDS) spectra of a corroded area, and a protected area of the TLC specimen inhibited by 100 ppmᵥ 1-hexanethiol shown in FIGS. 9A-9B.

FIGS. 11A and 11B are SEM images at two different magnifications (×100 and ×1000) taken of a TLC specimen inhibited using 100 ppmᵥ n-decanethiol.

FIG. 12 is a profilometry graph of the TLC specimen shown in FIG. 7C, after removal of corrosion products.

FIG. 13 is graph showing TLC rates of an X65 specimen as a function of 1-decanethiol concentration.

FIGS. 14A-14E are surface images of top of the line corrosion (TLC) specimens for different 1-decanethiol concentrations, i.e., A) none; B) 1 ppmᵥ; C) 10 ppmᵥ; D) 100 ppmᵥ; and E) 400 ppmᵥ, respectively, after 2 days.

FIG. 15 is a schematic drawing representing VCI distribution between liquid vapor, and condensed phases for TLC testing conditions, i.e., Solution Temperature (Tₛₒₗᵤₜᵢₒₙ)=77° C.; Gas Temperature (T_{gas})=65° C.; and Top Temperature (Tₜₒₚ)=32° C.

FIG. 16 is a schematic representation showing phase distribution of 1 ppmᵥ 1-decanethiol under the TLC conditions shown in FIG. 15, in accordance with a model disclosed herein.

FIG. 17 is a schematic representation showing phase distribution of 10 ppmᵥ 1-decanethiol under the TLC conditions shown in FIG. 15, in accordance with the model disclosed herein.

FIG. 18 is a schematic representation showing phase distribution of 100 ppmᵥ or 400 ppmᵥ 1-decanethiol under the TLC conditions shown in FIG. 15, in accordance with the model disclosed herein.

FIGS. 19A-19B are surface images of TLC specimens in the presence of A) 100 ppmᵥ 1-decanethiol; and B) 100 ppmᵥ 1-decanethiol and 500 ppmᵥ acetic acid.

### DETAILED DESCRIPTION

The term “aqueous environment” is used herein for convenience to include pure condensed water, brine, sea water, and other aqueous solutions that contain dissolved salts, organic acids, CO₂, H₂S, and other species leading to corrosion of metal surfaces in contact therewith, and ferrous metals in particular.

The term “ferrous metals” is used herein to refer to mild steel, and similar iron containing metals, which are susceptible to corrosion by oxidation from iron to ferrous ions, such as X65 steel.

The term “volatile corrosion inhibitor” is used herein to include one or more volatile thiol compounds.

The term “volatile thiol compound” is used herein to refer to thiol compounds that are capable of dispersing between an aqueous environment, a vapor or gaseous phase and a condensed aqueous phase.

The term “bottom of the line corrosion” or “BLC” refers to an oxidation process that occurs to the lower sections of a pipeline internal surface made from ferrous metals, transporting wet gas, where the transported liquids (brine and hydrocarbons) are flowing.

The term “top of the line corrosion” or “TLC” refers to an oxidation process that occurs to the upper sections of a pipeline internal surface made from ferrous metals, transporting wet gas, where the condensation of the vapors of volatile transported liquids (water and hydrocarbons) is occurring.

The term “open circuit potential” or “OCP” refers to a difference that exists in electrical potential between a metal solution interface and a reference electrode, which is also referred to as a “corrosion potential”.

Briefly described, in practice of embodiments of the present invention, an effective quantity of a volatile corrosion inhibiting (VCI) composition comprising a volatile thiol compound is introduced to fluids that are being transported within oil and/or gas well drilling and production systems and components, such as a wet gas line made from a ferrous metal, and the VCI composition suppresses or inhibits corrosion. The fluids being transported comprise water, hydrocarbons, as well as other gases such as CO₂ and H₂S.

In accordance with an embodiment of the present invention, the volatile thiol compound in the VCI composition is an aliphatic thiol. In accordance with another embodiment, the aliphatic thiol compound has a general formula (1): H—S—R, wherein R is selected from the group consisting of a straight-chain hydrocarbon moiety, branched hydrocarbon moiety, or cyclic hydrocarbon moiety. The aliphatic thiol compound may comprise an aliphatic group, which may be saturated or unsaturated, containing 5 to 18 carbon atoms. For example, R may be a C5 to C18 aliphatic group, C6 to C15 aliphatic group, or a C6 to C12 aliphatic group. Unsaturated aliphatic groups include alkenes and alkynes, but do not include aromatic groups, such as phenyl or benzyl. For example, phenylthiol or benzylthiol are not aliphatic thiol compounds, but are instead aromatic thiol and benzylic thiol compounds, respectively. In another embodiment, the aliphatic thiol compound is a primary thiol compound.

Exemplary volatile thiol compounds include, but are not limited to, pentanethiol, hexanethiol, heptanethiol, octanethiol, nonanethiol, decanethiol, undecanethiol, dodecanethiol, tridecanethiol, tetradecanethiol, pentadecanethiol, hexadecanethiol, heptadecanethiol, octadecanethiol, or combinations thereof. For example, where R in formula (1) is a straight chain hydrocarbon moiety, the volatile thiol compound can be 1-pentanethiol, 1-hexanethiol, 1-heptanethiol, 1-octanethiol, 1-nonanethiol, 1-decanethiol, 1-undecanethiol, 1-dodecanethiol, 1-tridecanethiol, 1-tetradecanethiol, 1-pentadecanethiol, 1-hexadecanethiol, 1-heptadecanethiol, 1-octadecanethiol, or combinations thereof. In one embodiment, the volatile thiol compound comprises at least one of 1-decanethiol or 1-hexanethiol. In another embodiment, the volatile thiol compound comprises at least 1-decanethiol.

In accordance with an aspect of the present invention, the volatile thiol compound may not be completely miscible with water, and therefore have a finite water solubility, which permits the volatile thiol compound to equilibrate between a solution phase and a vapor phase within the oil and gas well drilling and production system. The ability to partition between phases enables the volatile thiol compound to inhibit corrosion of top of the line regions that are not in continuous direct contact with the transported fluids. For example, the volatile thiol compound having a water solubility equal to or less than 200 mg/L at 25° C. is capable of partition between a solution phase and a vapor phase. Water solubilities (in mg/L) of exemplary volatile thiol compounds 1-hexanethiol, 1-decanethiol and 1-dodecanethiol are about 177.1, 2.14, and 0.225, respectively.

In order to increase the solubility of thiols in water, the aliphatic thiol compound may comprise an aliphatic group, which may have a polar functional group. For example, the polar functional group can be —NH₂, —OH, —CHO or —COOH or others. Higher solubility in water would lead to higher inhibition efficiency. Solubility in water (in mg/L) of exemplary volatile thiol compounds containing functional groups 11-mercaptoundecanoic acid (11-MUA) and 11-Mercapto-1-undecanol are about 13.8 and about 10.3, respectively

In accordance with another aspect of the present invention, the volatile thiol compound should have a measurable vapor pressure under the relevant operating parameters of temperature and pressure. For example, vapor pressures (in mmHg at 25° C.) of the exemplified volatile thiol compounds 1-hexanethiol, 1-decanethiol and 1-dodecanethiol are 4.5, 0.06 and 0.0076, respectively. Calculated vapor pressures of C15, C16, C17, and C18 thiol at 200° C. are 26.5, 16.7, 10.7, and 6.79 mmHg respectively (see Yaws, C. L.; Yang, H. C., Hydrocarbon Processing, 68(10), p 65-68, 1989). Thus, in accordance with an embodiment, the vapor pressure of the volatile thiol compound is at least 6 mmHg at 200° C. For example, the minimum vapor pressure of the volatile thiol compound may be equal to or greater than about 10 mmHg, about 16 mmHg, or about 26 mmHg (all measured at 200° C.). In accordance with another embodiment, the vapor pressure of the volatile thiol compound is at least 0.0005 mmHg at 25° C. For example, the minimum vapor pressure of the volatile thiol compound may be equal to or greater than about 0.0006 mmHg, about 0.001 mmHg, or about 0.005 mmHg (all measured at 25° C.).

The amount of the volatile thiol compound employed in the VCI composition to inhibit corrosion of the ferrous metal components may be varied over a wide range and satisfactory results thereby obtained. Inasmuch as thiols may be viewed as an undesirable constituent in the hydrocarbon fluid being transported, for example because of a disagreeable odor, it may be advantageous to employ only small quantities of one or more of the volatile thiol compounds in the VCI composition. Accordingly, in one embodiment, an effective amount of the volatile thiol compound may be initially used to inhibit corrosion of the ferrous metal, and then a lower amount may be effective thereafter to maintain the inhibiting effect. For example, the volatile thiol compound may be present in an amount from about 1 parts per million by volume (ppmᵥ) to about 1,000 ppmᵥ, such as 5 ppmᵥ, or 10 ppmᵥ, or 50 ppmᵥ.

The VCI composition may be comprised of a neat quantity of the volatile thiol compound. Alternatively, other constituents, such as solvents or conventional additives may also be blended with the volatile thiol compound. For example, it may be convenient to suspend or dissolve the volatile thiol compound in a suitable vehicle before introducing it into the produced fluids or the oil and gas well drilling and production system.

In accordance with an aspect of the present invention, Thiol compounds may be compatible with Monoethylene glycol (MEG). MEG is a common chemical added to wet gas pipelines to prevent the formation of hydrates.

In accordance with an embodiment of the present invention, the VCI composition is introduced into the produced fluids or the oil and gas well drilling and production system in a continuous or semi-continuous manner. For example, a metered amount of the VCI composition may be continuously injected to the oil and gas well drilling and production system, or the VCI may be periodically injected. Alternatively, batch treatments may also be employed.

According to an embodiment, the amount of the VCI composition introduced into the produced fluids or the oil and gas well drilling and production system is sufficient to provide a desired reduction in corrosion rate. For example, based on a baseline (uninhibited) corrosion rate that is determined by weight loss following ASTM G1 standard (“Standard practice for preparing, cleaning, and evaluating corrosion test specimens,” ASTM G01 (2003) 1-9), the corrosion rate for a ferrous material treated with the VCI composition of the present invention can be effectively reduced. While the effectiveness of a given volatile thiol compound will generally increase with increasing concentration, a sufficient quantity of the VCI composition comprising the volatile thiol compound may be used to reduce the corrosion rate by more than 50% of the baseline corrosion rate. For example, the corrosion rate may be reduced by 60%, 70%, 80%, 90%, or more.

Other measurements of the effectiveness of the VCI composition to inhibit corrosion may be derived from Open Circuit Potential (OCP) and Linear Polarization Resistance (Rₚ) experiments. In the volatile thiol screening test, a potentiostat was used to measure the Rₚ and the OCP of the ferrous metal sample. Corrosion rate in the water phase (BLC rate) is proportional to the corrosion current density (i_{corr}), which was then calculated by using a B constant value of 0.026 V/decade (i_{corr}=B/Rₚ/S in which S is surface area of the sample).

Non-limiting examples of a method for testing and evaluating VCI compositions, in accordance with the description, are now disclosed below. These examples are merely for the purpose of illustration and are not to be regarded as limiting the scope of the invention or the manner in which it can be practiced. Other examples will be appreciated by a person having ordinary skill in the art.

### Examples

In order to evaluate the inhibition ability volatile thiol compounds against top of the line corrosion (TLC), two experimental steps were utilized. In a first step, the VCI candidates were firstly tested in CO₂-saturated aqueous solution (1 wt % NaCl) to find out which chemicals, if any, showed inhibition properties. In a second step, the efficacy of the chosen VCI candidates for TLC was investigated in the vapor phase.

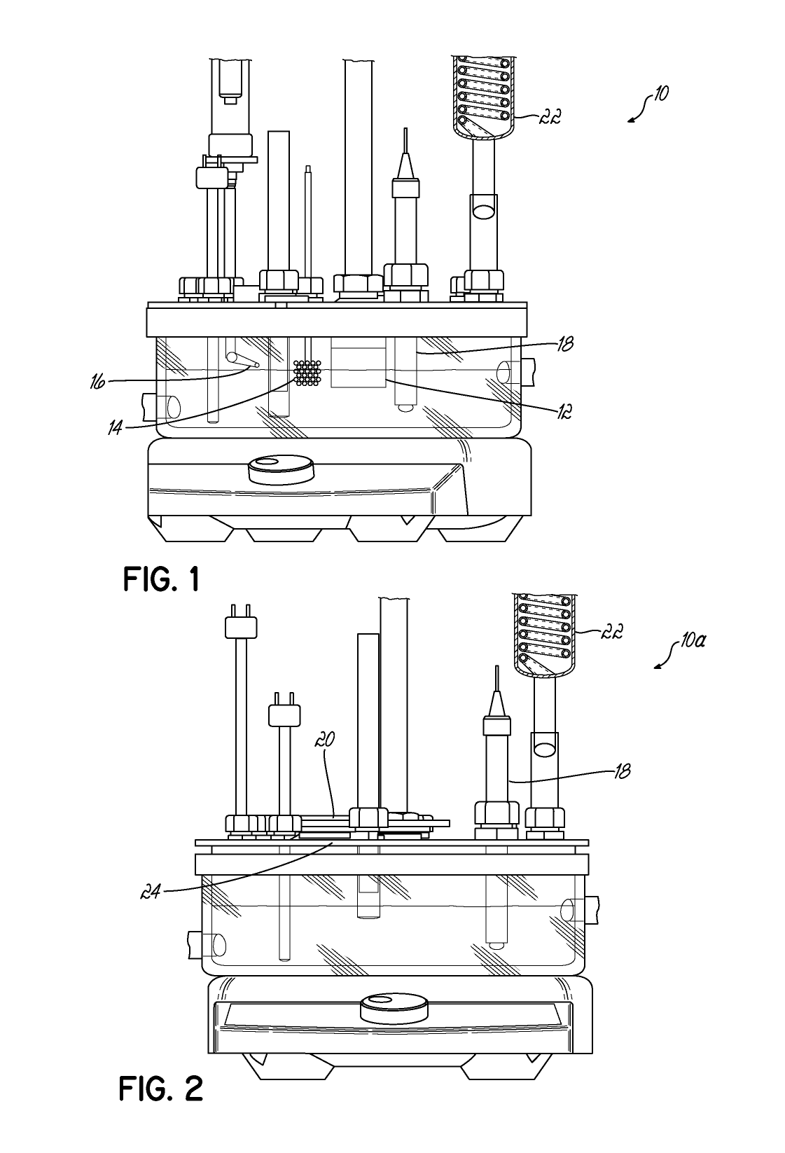

The experimental setup 10 for VCI screening tests in solution is shown in FIG. 1. A three electrode system was used in which an X65 rotating cylinder electrode (1000 RPM) was the working electrode 12, a Pt wire was used as counter electrode 14, and Ag/AgCl as the reference electrode 16. A pH probe 18 was used to measure the pH of the solution before and after adding the VCI candidates. The experiments were performed at 25° C. and 1 bar total pressure (pCO₂=0.96 bar).

The experimental setup used for evaluating the efficacy of the VCI candidates under TLC conditions 10a is shown in FIG. 2. The temperatures of the bottom solution and gas phases were controlled by a heater, while temperature of the specimen at the top was controlled by cooling water. Through coil 20, a condenser 22 was used to prevent water and VCI vapor loss.

In the VCI screening test, a potentiostat was used to measure the polarization resistance (Rₚ) of the X65 sample. Corrosion rate in the water phase (BLC rate) is proportional to the corrosion current density (i_{corr}) which was then calculated by using a B constant value of 0.026 V/decade (i_{corr}=B/Rₚ/S in which S is surface area of the sample).

In the VCI efficacy test, corrosion rate of the specimen at the top (TLC rate) was measured by weight loss following the ASTM G1 standard. Sample surface was characterized by Scanning Electron Microscopy (SEM)/Energy Dispersive X-ray Spectroscopy (EDS).

In these experiments, both rotating cylinder electrodes 12 and TLC specimens were made of X65 steel, the composition of which is shown in Table 1.

TABLE 1
Composition (wt %) of X65 carbon steel.

| | Element | | | | | | | | | | |
|---|---|---|---|---|---|---|---|---|---|---|---|
| | C | Cr | Mn | P | S | Si | Cu | Ni | Mo | Al | Fe |
| X65 | 0.06 | 0.05 | 1.54 | 0.01 | <0.01 | 0.25 | 0.04 | 0.04 | <0.01 | 0.04 | balance |

Test Matrix

The test matrix for the VCI screening in a 1 wt % NaCl solution is shown in Table 2. A baseline test was performed in the absence of the VCI candidate compound. Then, the corrosion rate of the X65 specimen was measured at the same condition in the presence of 400 ppmᵥ of 1-hexanethiol, 1-decanethiol, 1 dodecanethiol, and dibutyl sulfide. Dibutyl sulfide was used to compare the sulfide functional group versus the thiol functional group.

TABLE 2
Test matrix for VCI screening for BLC.

| | | | Concentration |
|---|---|---|---|
| N^{o} | Solution | VCI candidate | (ppm_{V}) |
| 1 | 1 wt % NaCl | — | — |
| 2 | 1 wt % NaCl | 1-hexanethiol | 400 |
| 3 | 1 wt % NaCl | 1-decanethiol | 400 |
| 4 | 1 wt % NaCl | 1-dodecanethiol | 400 |
| 5 | 1 wt % NaCl | Dibutyl sulfide | 400 |

Table 3 shows the test matrix for evaluating the efficacy of the VCI candidates for TLC. 1-hexanethiol, 1-decanethiol and 1-dodecanethiol were chosen based on the results in the VCI screening test, data from which will be shown below. In addition, the effect of acetic acid and MEG on the inhibition performance of the best VCI candidate was also taken into account.

TABLE 4
Test matrix for testing efficacy of VCI candidates for TLC.

| | 1- | 1- | 1- | 11- | | |
|---|---|---|---|---|---|---|
| Test | hexanethiol | decanethiol | dedecanethiol | MUA | Acetic acid | MEG |
| Number | (ppm_{V}) | (ppm_{V}) | (ppm_{V}) | (ppm_{V}) | (ppm_{V}) | (%) |
| 1 | — | — | — | — | — | — |
| 2 | 400 | — | 400 | — | — | — |
| 3 | 100 | — | — | 100 | — | — |
| 4 | — | 400 | — | — | — | 50 |
| 5 | — | 100 | — | — | — | — |
| 6 | — | 10 | — | — | — | — |
| 7 | — | 1 | — | — | — | — |
| 8 | — | 100 | — | — | 500 | — |

Testing Procedure

For the VCI screening tests, a 1 wt % NaCl solution was prepared and purged with CO₂ for 2 hours at 25° C. before injecting the VCI candidate. A X65 rotating cylinder electrode (RCE) was ground by abrasive paper, up to 600 grit, before inserting into the solution, which was performed about 1 hour after the VCI candidate was added. After that the Open Circuit Potential (OCP) and Linear Polarization Resistance (LPR) were measured every 10 minutes during an exposure time of 3-4 hours. The pH of the solution was measured before and after adding the VCI candidate. Electrolyte resistance (ER) was measured by Electrochemical Impedance Spectroscopy (EIS).

For the efficacy tests of VCI candidates for TLC, 1 wt % NaCl was also prepared and purged with CO₂ for 2 hours. In order to have a gas temperature of 65° C., the bottom solution was heated to 77° C. After that the selected concentration of the VCI candidates (Table 3) was added into the bulk solution. A weight loss specimen 24, after being ground (with up to 600 grit abrasive paper), was flush-mounted at the top of the experimental setup, controlling its temperature at 32° C. using cooling water. The weight loss sample and ER probe were added 0.1 hour after addition of the VCI candidate. The weight loss samples were withdrawn after 48 hours for surface analysis and weight loss measurement.

Results and Discussion

VCI Screening in Bulk Solution

The pH values of the bulk solution with and without inhibitor are shown in Table 4. The results indicate that the addition of VCI candidates did not significantly change the solution pH (Note: accuracy of the pH meter, RS 232 meter, Oakton instruments, 2008, is ±0.01). These results confirmed that, unlike amines, these VCI candidates do not undergo protonation.

TABLE 4
Solution pH of the VCI screening tests.

| | | | Concentration | Measured |
|---|---|---|---|---|
| N^{o} | Solution (NaCl) | VCI candidates | (ppm_{V}) | pH |
| 1 | 1 wt % | — | — | 3.91 |
| 2 | 1 wt % | 1-hexanethiol | 400 | 3.90 |
| 3 | 1 wt % | 1-decanethiol | 400 | 3.91 |
| 4 | 1 wt % | 1-Dodecanethiol | 400 | 3.89 |
| 5 | 1 wt % | Dibutyl sulfide | 400 | 3.93 |

Testing 1-Decanethiol

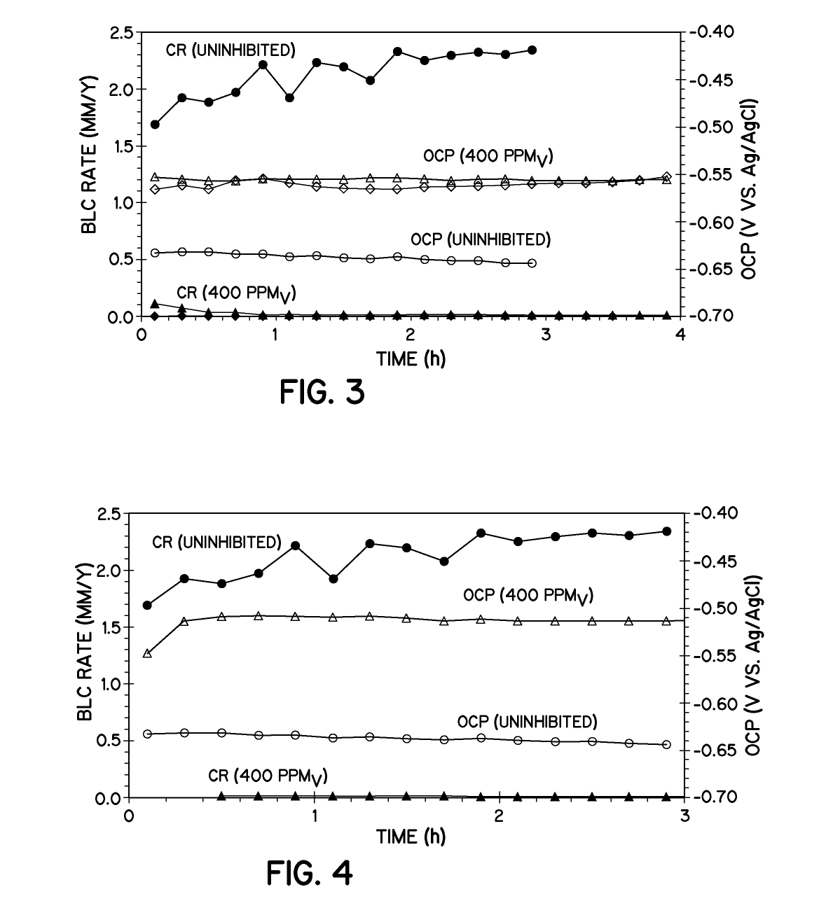

Bottom of the line corrosion rates (BLC rate) and open circuit potentials (OCP) of the X65 RCE in CO₂ saturated 1 wt % NaCl solution with and without 1-decanethiol are shown in FIG. 3. Without 1-decanethiol, the corrosion rate was about 2.3 mm/y and relatively constant after 2 hours. The corresponding OCP was around −0.64 V vs. Ag/AgCl. In the presence of 400 ppmᵥ 1-decanethiol, the corrosion rate was very low (i.e., 0.01 mm/y), while the OCP was about −0.56 V vs. Ag/AgCl. In order to verify the reproducibility of the results, the experiment with 1-decanethiol was repeated. The increase in the OCP and decrease in CR demonstrate that 1-decanethiol is a good anodic corrosion inhibitor.

Testing 1-Hexanethiol

BLC rates and OCPs of the X65 rotating cylinder electrode in CO₂ saturated 1 wt % NaCl solution with and without 1-hexanethiol are shown in FIG. 4. The presence of 400 ppmᵥ of 1-hexanethiol decreased the BLC rate from 2.3 mm/y to 0.01 mm/y, while the OCP increased from −0.64 V to −0.52 V vs. Ag/AgCl, implying that 1-hexanethiol is an anodic corrosion inhibitor.

Testing Dibutyl Sulfide

BLC rates and OCPs of the X65 rotating cylinder electrode in the CO₂ saturated 1 wt % NaCl solution with and without 1-hexanethiol were measured. Unlike 1-hexanethiol and 1-decanethiol, the presence of 400 ppmᵥ dibutyl sulfide did not significantly change either the corrosion rate or the OCP.

Effect of the Experimental Procedure on the Obtained Results

According to the TLC experimental procedure (see also FIG. 2), 400 ppmᵥ of the VCI candidates was injected into the glass cell before inserting the X65 electrode. For the four VCI candidates, the injected amount was higher than their respective solubility limits (shown in Table 5). 1-hexanethiol showed the highest solubility 1-dodecanethiol showed the lowest. In other words, after being injected not all of the VCI would dissolved in solution and a layer of the immiscible VCI would be expected to form at the liquid/gas interface, in an amount related to 400 ppmᵥ minus its solubility limit. When the X65 electrode was inserted into solution, the steel surface had to go through this immiscible inhibitor layer, which may have coated the working electrode surface.

TABLE 1
Solubility limit of the VCI candidates.

| | VCI's | | | |
|---|---|---|---|---|
| | 1- | 1- | 1- | Dibutyl |
| | hexanethiol | decanethiol | dodecanethiol | sulfide |
| Solubility* | 177.1 | 2.14 | 0.18 | 39.4 |
| (mg/L at 25° C.) | | | | |
| Solubility** | 212.35 | 2.58 | 0.22 | 46.9 |
| (ppm_{V} at 25° C.) | | | | |

*Solubility data obtained from www.lookchem.com.
**Converted to ppm by volume using density value.

In order to verify if the experimental procedure would affect the inhibition efficiency of the thiol inhibitors, one experiment with 1-decanethiol was performed, wherein the 1-decanethiol was added 1 hour after the insertion of the RCE. Thus, the only difference between the procedures is the order of addition of the VCI, i.e., after the insertion of the working electrode, in order to avoid contact with the immiscible layer.

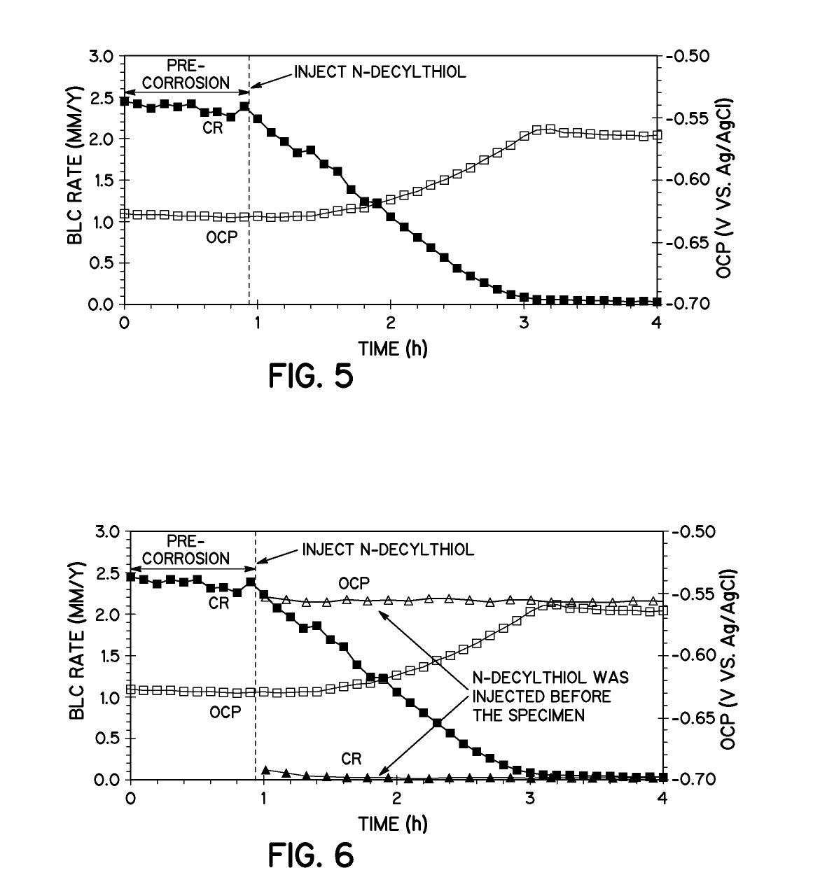

FIG. 5 shows the BLC rates and OCP values of the X65 electrode in the CO₂ saturated NaCl solution after injecting 400 ppmᵥ of 1-decanethiol (note that the X65 electrode was pre-corroded for almost one hour before adding 1-decanethiol). According to this result, the BLC rate slowly decreased from 2.4 mm/y to 0.05 mm/y, while the OCP gradually increased from −0.63 V to −0.56 V vs. Ag/AgCl. This transient period could be related to the diffusion of 1-decanethiol in solution.

In FIG. 6, the BLC rate and OCP values of the X65 electrode when 400 ppmᵥ of 1-decanethiol was injected before and after the electrode insertion are shown. It can be seen that the final BLC rate and final OCP values obtained from the two experimental procedures were the same. These results demonstrate that the high efficiency of the 1-decanethiol was not caused by the experimental procedure.

Efficacy of VCI Candidates for TLC

Based on the results of VCI screening in bulk solution, 1-hexanethiol, 1-decanethiol and 1-dodecanethiol demonstrated inhibitive properties and, therefore, were chosen for further evaluation in TLC testing. The physical properties of these three chemicals and 11-MUA are shown in Table 6.

TABLE 6
Physical properties of 1-hexanethiol, 1-decanethiol, 1-
dodecanethiol and 11-MUA.

| | VCI candidates | | | |
|---|---|---|---|---|
| | 1- | 1- | 1- | |
| | hexanethiol | decanethiol | dodecanethiol | 11-MUA |
| Pᵥₐₚₒᵣ | 4.5 | 0.06 | 0.007 | 3.7 × 10⁻⁵ |
| (mmHg at | | | | |
| 25° C.) | | | | |
| T_{boiling} (° C.) | 152 | 188 | 277 | 341 |
| Solubility | 212.4 | 2.6 | 0.22 | 13.8 |
| (ppm_{V} at | | | | |
| 25° C.) | | | | |
| Solubility | 1013.0 | 24.8 | 3 | 89 |
| (ppm_{V} at | | | | |
| 77° C.) | | | | |

TLC Inhibition Efficacy of Different VCI Candidates

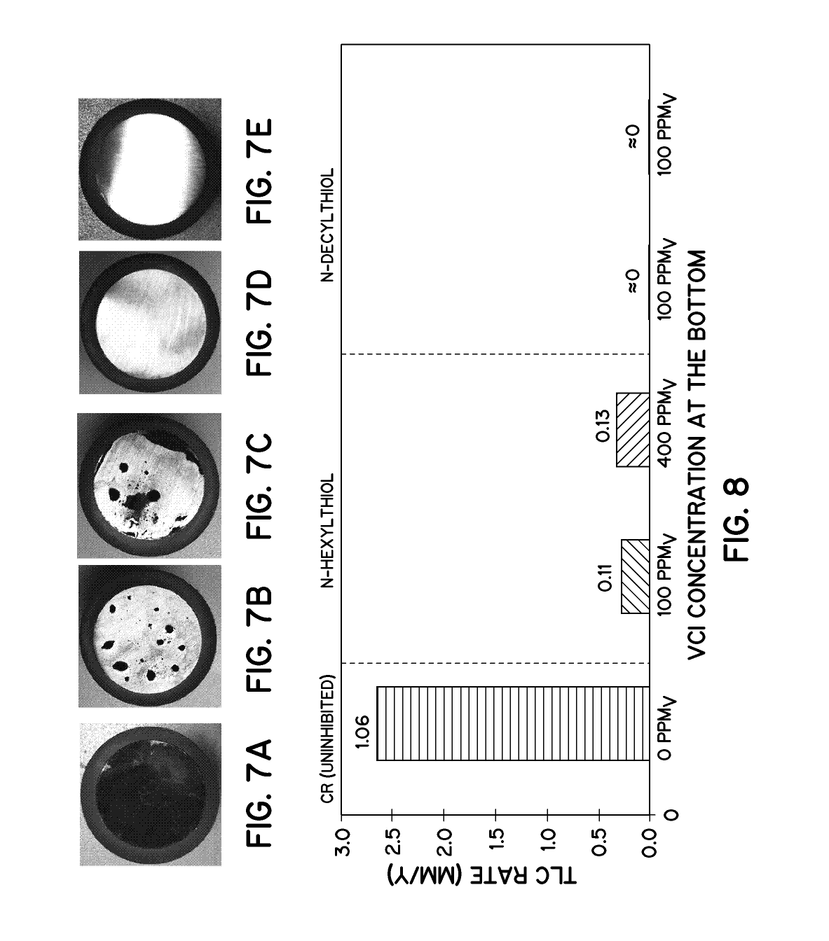

The surface images (FIGS. 7A-7E) and TLC rate obtained by weight loss (WL) (see FIG. 8) of the uninhibited and inhibited TLC specimens were obtained in accordance with the testing procedures described herein. Under the baseline conditions without any inhibitor (FIG. 7A), the X65 specimen was corroded at a TLC rate of 1.06 mm/y and its surface was fully covered by corrosion products. In the presence of 100 ppmᵥ (FIG. 7B) and 400 ppmᵥ (FIG. 7C) of 1-hexanethiol (in the bulk), the TLC rate was not significantly different (0.11 and 0.13 mm/y, respectively) but 10 times lower than the baseline test. The sample surface under these conditions was partially protected, as can be observed by the black areas on the surface where corrosion occurred. In contrast, in the presence of 100 and 400 ppmᵥ of 1-decanethiol (FIGS. 7D and 7E, respectively), the surface of the X65 TLC specimen was fully protected, the surface was clean and void of corrosion products after 2 days of experiment.

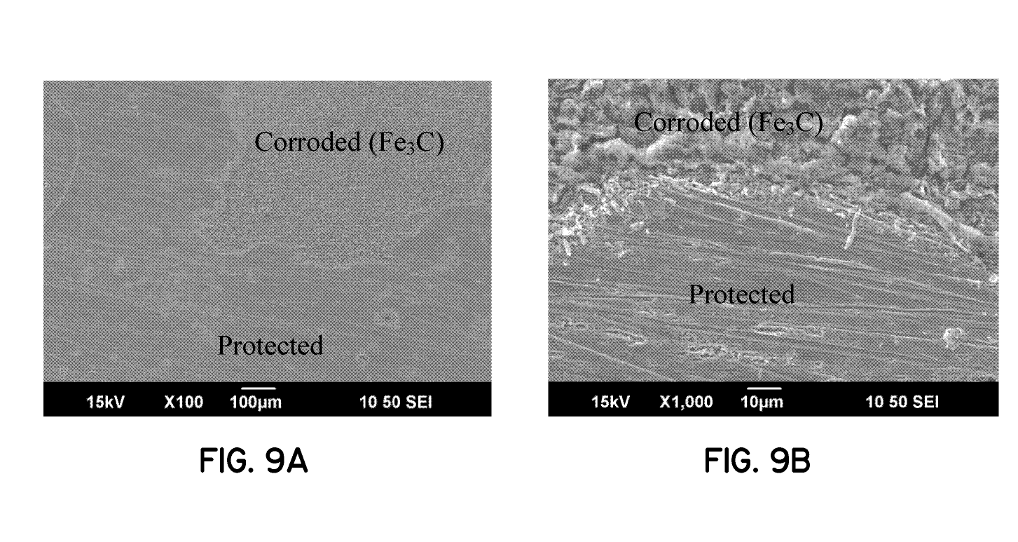

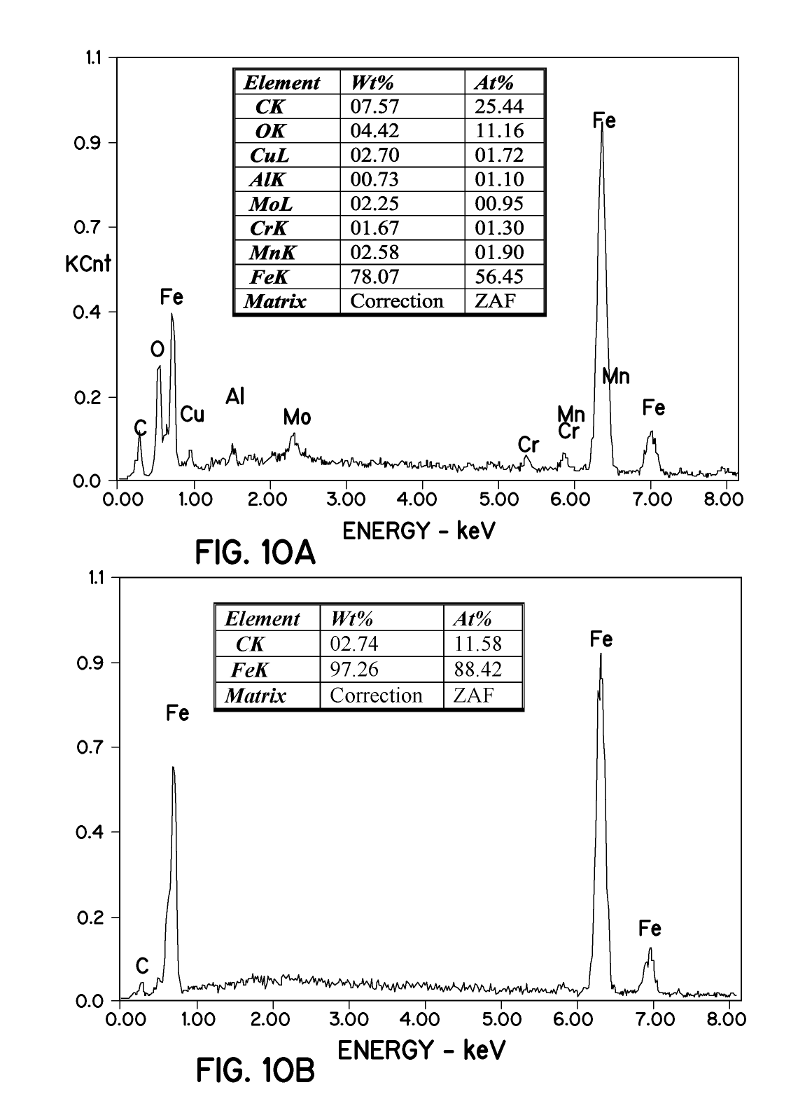

FIGS. 9A and 9B show SEM images at different magnifications of the TLC specimen surface when 100 ppmᵥ of 1-hexanethiol was added to the bulk solution. As mentioned above, 100 ppmᵥ of 1-hexanethiol (see FIG. 7B) was insufficient to fully protect the steel specimen exposed to the TLC conditions. The SEM images of this specimen surface confirmed this conclusion, showing alternating corroded and protected areas. FIG. 10A is an EDS of a corroded portion of the surface of the TLC specimen protected with 100 ppmᵥ 1-hexanethiol, which shows the presence of alloying elements typical of a Fe₃C layer. FIG. 10B is an EDS of a protected portion of the TLC specimen.

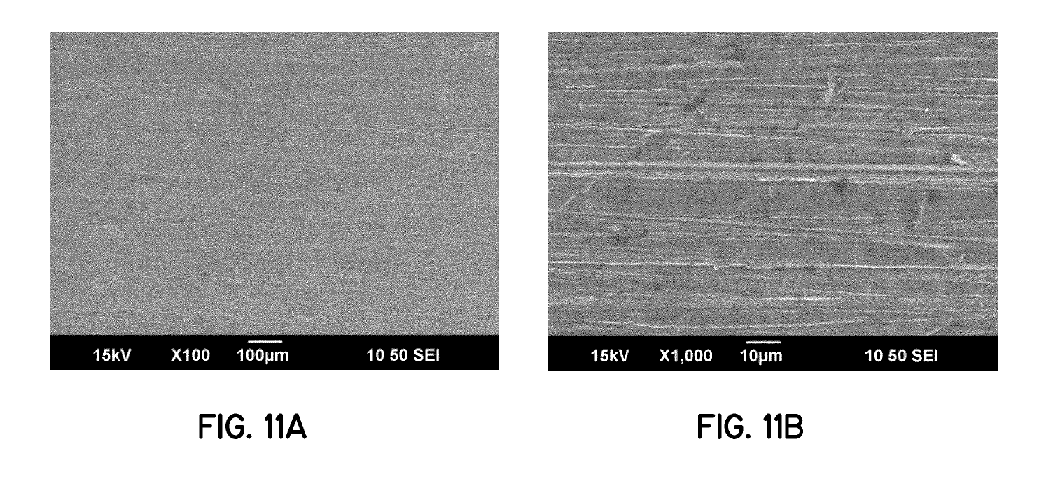

On the other hand, the SEM images (FIGS. 11A and 11B) of the steel surface exposed to the TLC conditions with 100 ppm 1-decanethiol in the bulk solution shows only scratches from grinding (preparation of samples before test) on the whole surface, suggesting a fully protected surface.

Table 7 shows a summary of results obtained with thiol compounds and 11-MUA. The results of testing 1-hexanethiol, 1-decanethiol, 1-dodecanethiol at the same concentration and 11-MUA demonstrated that 1-decanethiol, 1-dodecanethiol and 11-MUA give a better protection to the TLC specimen than 1-hexanethiol. Contrary to what is thought about volatile inhibitors (the higher the vapor pressure possibly the better the inhibition efficiency), 1-hexanethiol being more volatile than 1-decanethiol, 1-dodecanethiol and 11-MUA (Table 6) showed lower inhibition efficiency. This suggests that the vapor pressure of the VCI candidates is not the only factor that has to be considered when selecting volatile inhibitors.

TABLE 7
The summary results of testing thiols compound and 1-MUA

| | | Concentration at the bottom | TLC rate |
|---|---|---|---|
| N^{o} | VCI candidates | (ppm_{V}) | (mm/y) |
| 1 | Uninhibited | — | 1.06 |
| 2 | 1-hexanethiol | 400 | 0.13 |
| 3 | 1-decanethiol | 400 | 0.02 |
| 4 | 1-Dodecanethiol | 400 | 0.02 |
| 5 | 11-MUA | 100 | 0.02 |

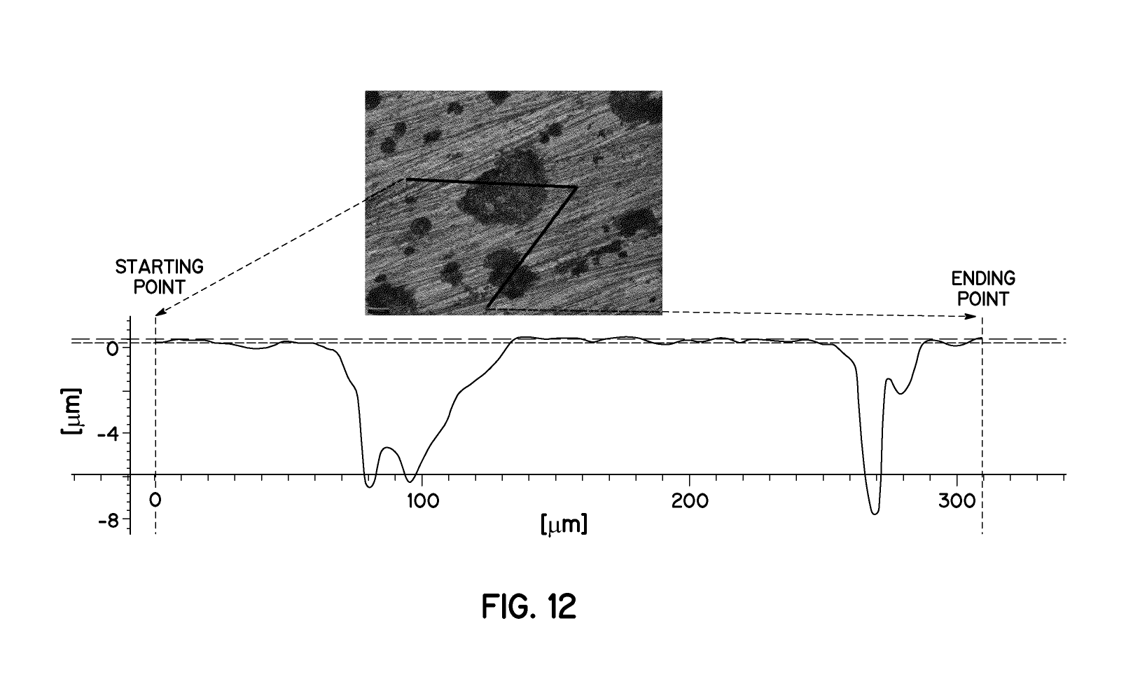

FIG. 12 shows the profilometry analysis of the WL samples exposed to TLC conditions (FIG. 7C) with 400 ppmᵥ of 1-hexanethiol (in the bulk) after removing the corrosion product. Since this VCI candidate was not able to fully protect the whole TLC specimen surface, localized corrosion was expected to happen. According to this result, the depth of the deepest pit on the surface was about 8 micrometers after the 2 day experiment corresponding to a localized corrosion rate of 1.46 mm/y, while the general corrosion rate by weight loss of this sample was only 0.13 mm/y.

Effect of 1-Decanethiol Concentration on its Inhibition Performance

Based on the results of testing 1-hexanethiol, 1-decanethiol and 1-dodecanthiol at the same concentration, it was shown that 1-decanethiol and 1-dodecanthiol gave a better TLC protection. This section presents a more detailed study of the inhibition performance of 1-decanethiol at different concentrations.

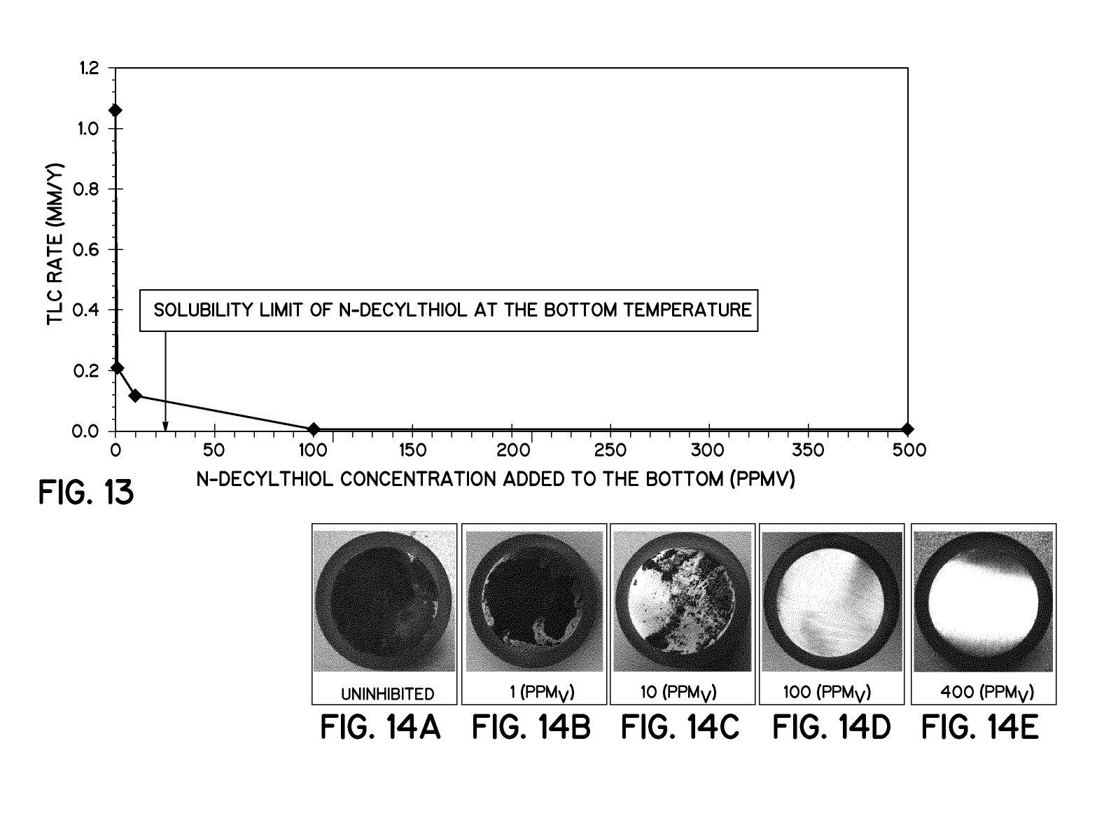

FIG. 13 plots the TLC rates of the X65 specimen as a function of 1-decanethiol concentration added into the bottom solution. The TLC rate generally decreased with an increase in 1-decanethiol concentration. At the concentrations (1 ppm, and 10 ppmᵥ) below the solubility limit, the corrosion rate clearly decreased with increasing concentration. This is logical since the more 1-decanethiol added in the bottom solution the more 1-decanethiol that reached the flush mounted steel surface. At concentrations above the solubility limit (100 ppmᵥ and 400 ppmᵥ), the TLC rate is already very low and no further decrease in the corrosion rate is observed. Above the solubility limit, the TLC specimen was fully protected with no measurable weight loss for the calculation of corrosion rate.

FIGS. 14A-14E show the surface images of the TLC specimens at the different 1-decanethiol concentrations added at the bottom. From the left to the right, 1-decanethiol concentration increases from none (FIG. 14A), 1 ppmᵥ (FIG. 14B), 10 ppmᵥ (FIG. 14C), 100 ppmᵥ (FIG. 14D), and 400 ppmᵥ (FIG. 14E). These images are consistent with the TLC rates shown in FIG. 13.

In order to explain the effect of 1-decanethiol concentration on TLC inhibition, its distribution in liquid, vapor and condensed phases was calculated based on its vapor-liquid equilibrium and solubility as follows.

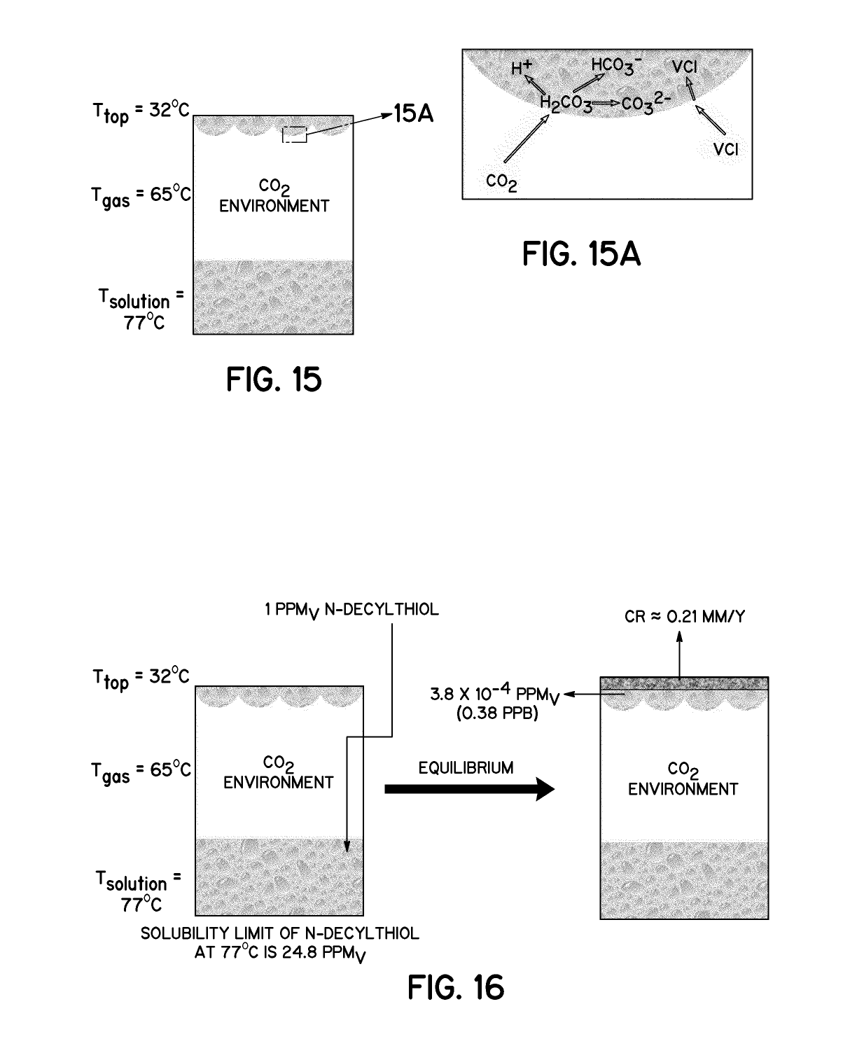

FIG. 15 indicates the conditions for the TLC tests. The temperatures at the bottom, in the vapor phase, and at the top were 77° C., 65° C., and 32° C. respectively. The experiment was performed in the CO₂ environment (total pressure=1 atm). VCI molecules in the vapor phase dissolved (together with carbonic species) in the condensed water and did not protonate, as mentioned above (see Table 4).

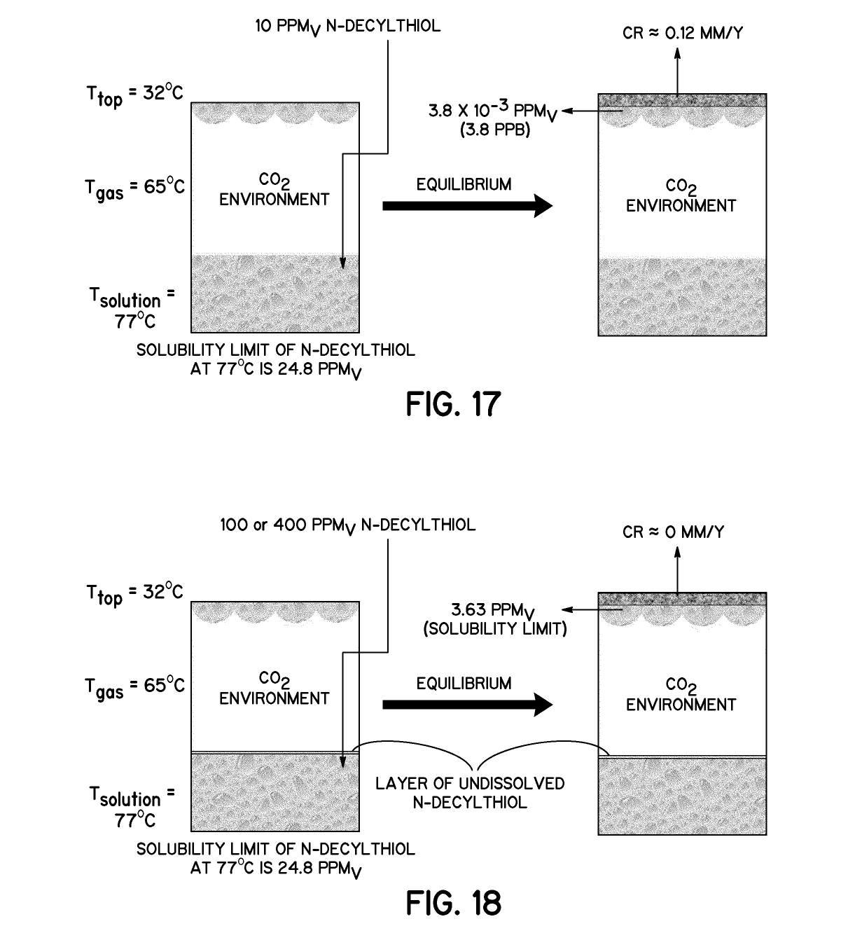

FIGS. 16 and 17 are schematics that represent the equilibrium of 1-decanethiol in the experimental system when 1 ppmᵥ (FIG. 16) and 10 ppmᵥ (FIG. 17) were added into the bottom. When 1 ppmᵥ of 1-decanethiol was added, all of it dissolved in solution to create a homogeneous distribution therein since this amount was lower than its solubility limit at 77° C. (24.8 ppmᵥ). From the mole fraction of 1-decanethiol at the bottom and the temperatures, it is possible to calculate the concentration of 1-decanethiol at the top, which is 0.38 ppb in this case (the details of how to calculate this concentration are described below). Even though there was only 0.38 ppb of 1-hexanethiol at the top, the TLC significantly decreased from 1.06 mm/y to 0.21 mm/y. When the concentration of 1-decanethiol increased from 1 ppmᵥ to 10 ppmᵥ, which is still lower than the solubility limit of 1-decanethiol, the TLC rate further decreased (0.21 mm/y vs. 0.12 mm/y) because there was more 1-decanethiol at the top (0.38 ppb vs. 3.8 ppb).

When the amount of 1-decanethiol added into the bottom is higher than its solubility limit, for example 100 and 400 ppmᵥ, an immiscible layer of 1-decanethiol would be formed on the top of the bottom solution (FIG. 18). This layer will not prevent water from evaporating but will increase the 1-decanethiol concentration in the vapor phase and the condensed water at the top. According to the calculations, the concentration of 1-decanethiol at the top will be higher than its solubility limit at 32° C. (3.63 ppmᵥ), therefore, there will also be an immiscible layer at the vapor/liquid interface at the top. Without being bound by any particular theory, this could explain why the TLC specimen was completely protected.

Effect of Acetic Acid on the Inhibition Performance of 1-Decanethiol.

Table 8 shows the measured pH for the bottom solution in the presence of 1-decanethiol and acetic acid. According to this table, the presence of 1-decanethiol did not change the pH of the solution but the presence of 500 ppmᵥ acetic acid decreased the pH by about 1 pH unit.

TABLE 8
Measured pH of the bottom solution with and without the
presence of acetic acid.

| | | | | Measured |
|---|---|---|---|---|
| N^{o} | Bulk solution (NaCl) | 1-decanethiol | Acetic acid | pH |
| 1 | 1 wt % | — | — | 4.17 |
| 2 | 1 wt % | 100 ppm_{V} | — | 4.19 |
| 3 | 1 wt % | 100 ppm_{V} | 500 ppm_{V} | 3.32 |

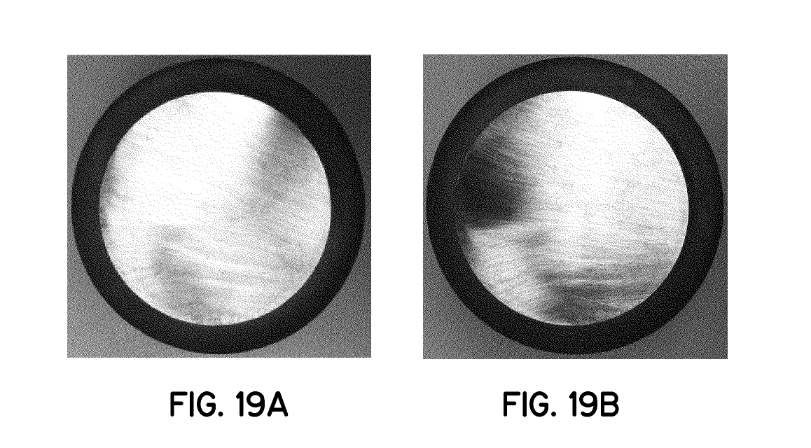

Acetic acid is a volatile chemical, therefore it is expected that it will decrease the pH not only of the bottom solution but also at the top in the condensed water. A low pH presents an aggressive environment for the TLC specimen. However, the experimental results shown in FIG. 19 indicate that 100 ppmᵥ of 1-decanethiol was effective in fully protecting the X65 specimen in the presence of 500 ppmᵥ of acetic acid.

Effect of MEG on the Inhibition Performance of 1-Decanethiol.

Monoethylene glycol (MEG) is a common chemical added to wet gas pipelines to prevent the formation of hydrates. The same procedure was used to study the compatibility of MEG with 1-decylthiol. The average vapor phase corrosion rate with or without 50 wt. % MEG proved to be very similar, around 0.04 mm/y. It is known that the presence of 50 wt. % MEG has very little effect on the condensation rate.

The results in the tested water phase (VCI screening in bulk solution) demonstrated that 1-hexanethiol, 1-decanethiol and 1-dodecanethiol had inhibition properties while dibutyl sulfide did not. At the same concentration, 1-decanethiol and 1-dodecanethiol provided a better protection against TLC than 1-hexanethiol even though it has lower volatility. This indicates a more complex interaction between the inhibitor's tail or the inhibitor's solubility than initially expected. 1-decanethiol, 1-dodecanethiol and 11-MUA are viable VCIs components that inhibit both BLC and TLC in ferrous metal components used in the oil and/or gas well drilling and production systems.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What is claimed is:

1. A method of inhibiting corrosion of ferrous metals in oil and gas well drilling and production systems, comprising adding to said system an effective quantity of a volatile corrosion inhibiting (VCI) composition comprising a volatile thiol compound, wherein said effective quantity is an amount effective to reduce corrosion.

2. The method of claim 1, wherein the volatile thiol compound is an aliphatic thiol.

3. The method of claim 2, wherein the aliphatic thiol compound has a general formula: H—S—R, wherein R is selected from the group consisting of a straight-chain hydrocarbon moiety, branched hydrocarbon moiety and cyclic hydrocarbon moiety.

4. The method of claim 2, wherein the aliphatic thiol comprises an aliphatic group, said aliphatic group including a functional group selected from the group consisting of —NH₂, —OH, —CHO and —COOH.

5. The method of claim 2, wherein the aliphatic thiol compound comprises an aliphatic group containing 5 to 18 carbon atoms.

6. The method of claim 1, wherein the volatile thiol compound is selected from the group consisting of pentanethiol, hexanethiol, heptanethiol, octanethiol, nonanethiol, decanethiol, undecanethiol, dodecanethiol, tridecanethiol, tetradecanethiol, pentadecanethiol, hexadecanethiol, heptadecanethiol, octadecanethiol, and combinations thereof.

7. The method of claim 1, wherein the volatile thiol compound is selected from the group consisting of 1-pentanethiol, 1-hexanethiol 1-heptanethiol, 1-octanethiol, 1-nonanethiol, 1-decanethiol, 1-undecanethiol, 1-dodecanethiol, 1-tridecanethiol, 1-tetradecanethiol, 1-pentadecanethiol, 1-hexadecanethiol, 1-hexadecanethiol, 1-heptadecanethiol, 1-octadecanethiol, 11-mercaptoundecanoic acid and combinations thereof.

8. The method of claim 1, wherein the volatile thiol compound selected from the group consisting of is 1-decanethiol, 1-dodecanthiol, 11-mercaptoundecanoic acid and combinations thereof.

9. The method of claim 1, wherein the effective quantity is greater than 1 parts per million (ppm) by volume.

10. The method of claim 1, wherein the volatile thiol compound has a vapor pressure greater than 0.0005 mmHg at 25° C.

11. The method of claim 1, wherein the volatile thiol compound has a water solubility equal to or less than 200 mg/L at 25° C.

12. The method claimed in claim 1 wherein said thiol is compatible with mono ethylene glycol.

13. A stabilized humid natural gas composition, comprising light hydrocarbon compounds, water vapor, and a volatile corrosion inhibiting (VCI) composition comprising a volatile, C5-C18 aliphatic thiol compound in an amount effective to reduce corrosion of ferrous metals.
